(19) United States
(12) Patent Application Publication
(10) Pub. No.: US 2018/0170393 A1
(43) Pub. Date: Jun. 21, 2018

(54) METHOD AND SYSTEM FOR EVALUATING THE DRIVING BEHAVIOUR OF A VEHICLE OPERATOR WITH A MOTOR VEHICLE

(71) Applicant: INIT Innovative Informatikanwendungen in Transport-, Verkehrs- und Leitsystemen GmBh, Karlsruhe (DE)

(72) Inventors: Christian Decker, Karlsruhe (DE); Simon Anderer, Waldbronn (DE)

(21) Appl. No.: 15/737,304

(22) PCT Filed: Jun. 15, 2016
(86) PCT No.: PCT/DE2016/200275

§ 371 Date: Dec. 17, 2017

(30) Foreign Application Priority Data
Jun. 17, 2015 (DE) 10 2015 211 171.7
Jul. 13, 2015 (DE) 10 2015 213 108.4

(51) Int. Cl. B60W 40/09; G07C 5/00

(52) U.S. Cl. CPC B60W 40/09; B60W 2050/005; G07C 5/008

(57) ABSTRACT

The invention relates to a method for evaluating the driving behaviour of a vehicle operator with a motor vehicle, in particular in local public transport or in inner-city traffic, preferably for use in vehicle fleets, wherein parameters for describing the driving behaviour are determined, wherein fuel consumption over time is determined as a parameter, wherein the position of the gas pedal over time is determined as another parameter, wherein vehicle operator-specific characteristic values for a drive of the vehicle operator are derived or calculated from the determined parameters, wherein the vehicle operator-specific characteristic values are compared with predefined threshold values, and wherein conclusions about the driving behaviour of the vehicle operator for the drive are drawn from the comparison of the vehicle operator-specific characteristic values with the threshold values. The invention also relates to a corresponding system for evaluating the driving behaviour of a vehicle operator with a motor vehicle.

The invention relates to a method and a system for evaluating the driving behavior of a vehicle operator with a motor vehicle, in particular in public mass transit, or in inner-city traffic, preferably for use in vehicle fleets. Moreover, the invention relates to a corresponding computer program.

Methods for determining and evaluating the driving behavior of a vehicle operator have been known for years in the practice. In the simplest case, this relates to tachographs, for example. These indicate driving times, rest periods, driving time interruptions, additional kilometers driven, and the speed at which the vehicle is driven. Moreover, a tachometer that records motor rotational rates is known. The data recorded by the tachographs reflect the driving behavior of the vehicle operator, and are used in particular for enforcing compliance with driving and rest periods.

Furthermore, a method for driving behavior evaluation is known from DE 100 01 261 A1. With the method known therefrom, the current driving state is continuously determined via a driving state determination unit in order to determine the driving behavior or manner of driving. As relevant perimeters, the vehicle speed, positive or negative vehicle acceleration, the distance to a vehicle in front, and optionally the activation of signal lights, are recorded. The driving behavior recorded on the basis of these parameters is compared with an optimal driving behavior, such that improvement recommendations regarding his driving behavior can be displayed to the vehicle operator.

Corresponding systems are used, for example, with vehicle fleets of transport businesses in order to improve driving safety and fuel economy, reduce in carbon dioxide emissions, and decrease wear to the vehicle.

With the systems known from the prior art, it is problematic that these systems are extremely expensive, due to the elaborate sensor system. A further substantial disadvantage is that these systems are not suited to evaluating the driving behavior of a vehicle operator who is active in public mass transit or inner-city traffic. Driving in public mass transit is characterized by, among other things, very short driving intervals, specifically between two stops. Due to the traffic situations in urban areas, which include, for example, pedestrians or quick lane changes in a continuous traffic flow, acceleration and braking procedures occur repeatedly in such driving intervals in short intervals. The parameters for determining the driving behavior known from the prior art are not suitable for such traffic situations. By way of example, fuel consumption may vary considerably, depending on the volume of traffic, such that the vehicle operator may have a higher fuel consumption, depending on general conditions that the vehicle operator has no control over. Consequently, a fair and objective evaluation of a vehicle operator in particular regarding fuel consumption resulting from his driving behavior is extremely difficult if not impossible.

The object of the present invention is therefore to design and develop a method and a system for evaluating the driving behavior of a vehicle operator with a motor vehicle of the type specified in the introduction, with which it is possible to determine or evaluate the driving behavior of a vehicle operator, in particular regarding fuel consumption, with simple structural means, preferably without requiring an elaborate sensor system.

The above object shall be obtained according to the invention through the features of Claim 1. Accordingly, a method is given for evaluating the driving behavior of a vehicle operator with a motor vehicle, in particular in public mass transit or inner-city traffic, preferably for use in vehicle fleets, wherein parameters describing the driving behavior are determined, wherein fuel consumption over the course of time is determined as a parameter, wherein the position of the gas pedal over the course of time is determined as a further parameter, wherein characteristic values specific to the vehicle operator for a route driven by the vehicle operator are derived or calculated from the determined parameters, wherein the vehicle operator-specific characteristic values are compared with predefined threshold values, and wherein conclusions are drawn regarding the driving behavior of the vehicle operator for the route from the comparison of the vehicle operator-specific characteristic values with the threshold values.

With respect to the system according to the invention, the above object is achieved with the features of Claim 15. Accordingly, a system is given for evaluating the driving behavior of a vehicle operator with a vehicle, in particular in public mass transit or inner-city traffic, preferably for use with vehicle fleets, comprising a detection device disposed in the motor vehicle for determining parameters describing the driving behavior and comprising an evaluation device for evaluating the driving behavior of the vehicle operator, wherein the detection device includes means for determining fuel consumption over the course of time, wherein the detection device also includes means for determining the position of the gas pedal over the course of time, and wherein the evaluation device is configured such that it calculates vehicle operator-specific characteristic values for a route driven by the vehicle operator from the determined parameters, compares the vehicle operator-specific characteristic values with predefined threshold values, and draws conclusions regarding the driving behavior of the vehicle operator for the route from the comparison of the vehicle operator-specific characteristic values with the threshold values.

Lastly, the above object is achieved through the features of Claim 16, according to which a computer program containing program code is given, which serves for executing the method according to the invention when the computer program is executed on a computer.

In accordance with the invention it has first been noted that with respect to an objective and meaningful evaluation of the driving behavior of a vehicle driver, merely taking into account the fuel consumption is a weak indicator, or is unsuitable. Moreover, it has been noted in accordance with the invention that the fundamental object of the invention can be achieved in a clever and simple manner through the determination of the position of the gas pedal, because this parameter reflects the driving behavior, or manner of driving, of the vehicle operator. It has been noted thereby that this parameter describes the driving behavior in an ideal manner, in particular with very short intervals such as those encountered in public mass transit or inner-city traffic. In accordance with the invention, the fuel consumption and the position of the gas pedal over the course of time are determined for this, wherein respective vehicle operator-specific characteristic values regarding a route driven by the vehicle operator are derived or calculated from the two determined parameters. The derived vehicle operator-specific characteristic values thus comprise a characteristic value relating to the fuel consumption and a characteristic value relating to the gas pedal position. The vehicle operator-specific characteristic values are compared with corresponding predefined threshold values relating to fuel consumption and the gas pedal position, wherein conclusions are drawn from the comparison of the vehicle operator-specific characteristic values with the threshold values relating to the driving behavior of the vehicle driver with respect to the route driven.

Consequently, a determination or evaluation of the driving behavior of a vehicle operator regarding fuel consumption can be obtained with the method according to the invention and the system according to the invention, as well as with the computer program according to the invention, in a clever manner and with simple structural means, wherein a further advantage of the method according to the invention, or the system according to the invention, is that the position of the gas pedal can be detected extremely easily. The method according to the invention can be executed by the system according to the invention with simple apparatuses.

At this point it should be expressly noted that the term “fuel” is to be understood in the broadest sense, specifically as any energy source that may be provided for a vehicle. This can be gasoline, diesel, natural gas, electrical energy, hydrogen, etc.

It is further noted that a route driven by a vehicle operator can be understood as the driving of the vehicle operator during a work shift, e.g. a bus driver. Thus, the fuel consumption and the associated gas pedal position are determined while a vehicle operator is driving in the framework of his shift.

The determined fuel consumption and the determined position of the gas pedal, or the characteristic values related to the fuel consumption and the gas pedal position derived therefrom can be advantageously placed in relation to one another. Thus, the derived characteristic value relating to fuel consumption and the derived characteristic value relating to the gas pedal position can be placed in relation to one another in an ideal manner. Consequently, it is possible to obtain an objective and meaningful analysis of the driving behavior of a vehicle operator with a motor vehicle in a clever and simple manner through the direct coupling of the two parameters describing the driving behavior, or through the depiction thereof. Moreover, improvement suggestions can be proposed to the vehicle operator to improve fuel economy based on this depiction, specifically through optimizing his driving behavior.

In a further advantageous manner, it is possible to only take predefined driving sections of a route into account for determining the parameters that describe the driving behavior, in particular the parameter relating to the fuel consumption and the parameter relating to the gas pedal position, or for calculating the characteristic values from the determined parameters. It is noted thereby that a driving section of a route relates to a time interval of the driving period in which the vehicle is substantially moving. Typical interval driving during a route, or during a work shift of a vehicle operator, e.g. a bus driver, can be taken into account thereby. Downtimes, breaks and/or idle activity of the vehicle are not intended to be taken into account thereby. The route of a vehicle operator is already known, such that suitable driving sections can be established in advance. In this manner, meaningful parameter data, describing the driving behavior of the vehicle operator in an ideal manner, can be acquired. In this manner, it is possible to obtain or filter fuel consumption data relating to driving behavior.

In a particularly advantageous manner, the predefined driving sections can exhibit a maximum driving section time period of 15 minutes, preferably a maximum of 5 minutes, particularly preferably a maximum of 2 minutes, very particularly preferably a maximum of 1 minute. Moreover, the predefined driving sections can ideally exhibit a maximum driving section period of at least 20 seconds. In this manner, for practical purposes, relatively short interval driving can be taken into account for determining the parameters or the characteristic values, which optimally reflect different performances in the driving behavior of vehicle operators during acceleration and braking procedures. Consequently, the driving behavior of the vehicle operator can be effectively detected and analyzed through the collective determination, taking fuel consumption and the associated gas pedal position into account.

With regard to the determination of the most meaningful values, the route, or the aggregate driving sections, if applicable, can amount to a total of at least 30 minutes of driving time. In this manner, a reliable fuel consumption value can be obtained, in particular for calculating fuel consumption for the route. The driving time of 30 minutes can be distributed over numerous shorter driving sections thereby. Even better and more consistent fuel consumption values can be obtained when the route includes a driving time of at least 60 minutes. In this manner, it is possible to avoid weighting anomalies in the acquired data too heavily over a route driven by the vehicle operator, in particular with respect to fuel consumption.

With regard to the determination of a suitable characteristic value for a route for use in the framework of the comparison process or the comparison operation, the average fuel consumption of the vehicle operator can be calculated for a route, or the route, as a vehicle operator-specific characteristic value relating to the fuel consumption. In this manner, the driving behavior for a route with respect to fuel consumption—ideally coupled thereby with the comparison of corresponding characteristic values relating to the gas pedal position with the predefined threshold values provided for this—can be determined and evaluated in a suitable and objective manner with a characteristic value selected in this manner in the framework of the comparison with a predefined threshold value. This enables, in a clever manner—and with relatively little effort—the determination of how the driving behavior of the vehicle operator affects the fuel consumption.

Regarding the determination of a suitable characteristic value for a route for use in the comparison operation, the frequency of a predefined actuation extent of the gas pedal can be drawn on as a vehicle operator-specific characteristic value. In an advantageous manner, the relative frequency of a predefined actuation extent of the gas pedal can be calculated for this. The threshold value can be the frequency of a predefined minimum actuation extent thereby. The minimum actuation extent is preferably in a range of 50% to 100% actuation of the gas pedal. The minimum actuation extent particularly preferably lies in a range of 50% to 75% actuation of the gas pedal. Very particularly preferably, the minimum actuation extent lies in a range of 50% to 60% actuation of the gas pedal. Thus, in order to calculate the characteristic value relating to the gas pedal position, the absolute and/or relative frequency with which the gas pedal is actuated, e.g. at least 70%, or is actuated at least 50%, can be determined, for example. In this manner, the driving behavior of a vehicle operator can be particularly easily evaluated, because actuations to this extent, or these positions of the gas pedal, result in higher fuel consumption.

With regard to the determination of a suitable threshold value for the comparison operation, the average of the mean fuel consumption values for a predefined number of vehicle operators can be calculated or determined as the threshold value relating to fuel consumption. By way of example, the average of the fuel consumption values of vehicle operators lying within the 70^{th} percentile is ideally suitable for this. Particularly preferably, the average of the fuel consumption values of vehicle operators lying within the 60^{th} percentile can be selected. Very particularly preferably, the average of the fuel consumption values of vehicle operators lying within the 50^{th} percentile can be calculated. In this manner, appropriate results are obtained in the framework of the comparison operation, depending on existing data from vehicle operators, e.g. a vehicle fleet. Moreover, the threshold value is selected such that it is ensured in an advantageous manner that vehicle operators are present in a vehicle fleet who have a lower fuel consumption than the threshold value, and that vehicle operators are present in the fleet who have higher consumption values. Consequently no arbitrary and unrealistic threshold values are defined that appear to be nearly impossible to achieve for a vehicle operator.

Moreover, it is conceivable that the average of the, preferably relative, frequencies of a predefined actuation extent, or minimum actuation extent, of the gas pedal are calculated or determined as the threshold value relating to the gas pedal position. This concerns absolute and/or relative frequencies of predefined gas pedal positions, or predefined actuation extents from the distribution of the relative frequencies for all gas pedal positions belonging to the routes or belonging to the fuel consumption values of vehicle operators determined from the routes, that are taken into account in calculating the threshold value relating to fuel consumption. The minimum actuation extent that is to be taken in to account can advantageously lie in a range of 50% to 100% actuation of the gas pedal. Particularly preferably, the minimum actuation extent of the gas pedal can lie in a range of 50% to 75% actuation of the gas pedal, and very particularly preferably, in a range of 50% to 60% actuation of the gas pedal.

Regarding an advantageous and simple evaluation, the driving behavior of the vehicle operator for the route, or for a route, can either be classified as being “in need of improvement” or “not in need of improvement,” on the basis of the comparison of the characteristic values with the corresponding threshold values.

In order to create a comprehensive evaluation of the driving behavior of the vehicle operator, the parameters describing the driving behavior can be determined for numerous drives by the vehicle operator, wherein for each drive, a vehicle operator-specific characteristic value relating to fuel consumption and a vehicle operator-specific characteristic value relating to the gas pedal position are derived or calculated.

In an advantageous manner, a preferably dichotomous classification of numerous drives by the vehicle operator can be checked by means of a hypothesis test, in particular by means of a binomial test, wherein conclusions can be drawn on the evaluation of the driving behavior of the vehicle operator from the check. In this manner, a consistent and reliable determination and evaluation of the vehicle drive can be obtained with respect to his driving behavior over the course of numerous drives or work shifts.

In a particularly advantageous manner, it can be determined with the hypothesis test whether the vehicle operator will drive a route with a driving behavior not in need of improvement with a probability of p≥0.5. In this manner, it can be determined in a clever manner, whether—with a predetermined significance value of 0.1, for example—a driving of a route, or a driving behavior, is not in need of improvement to an extent indicating that this is not merely random.

In order to obtain further improvement, or in order to react to improved driving behaviors of vehicle operators, e.g. in a vehicle fleet, the threshold values can be re-calculated and/or updated when the driving behavior of a predefined portion of the vehicle operators is evaluated as not being in need of improvement. In this manner, the threshold values for the comparison operation are updated or readjusted, such that improvements in the driving behaviors of vehicle operators are taken into account. Moreover, the reverse is also conceivable, specifically if the driving behaviors of vehicle operators become worse, e.g. because the threshold values for the vehicle operators of a vehicle fleet have been selected too strictly.

Moreover, it should be noted that the features specified above regarding the method according to the invention and/or regarding the advantageous designs can also represent a device emphasis. A combination of these features with the features relating to the system Claims is not only possible, but advantageous.

There are now various possibilities for embodying and developing the teachings of the present invention in an advantageous manner. In this regard, reference is made on one hand to the Claims subordinate to Claim 1, and on the other hand, to the following explanation of preferred exemplary embodiments of the invention, based on the drawings. Preferred designs and further developments of the teachings shall also be explained in general in conjunction with the explanations of the preferred exemplary embodiments of the invention based on the drawings. In the drawings:

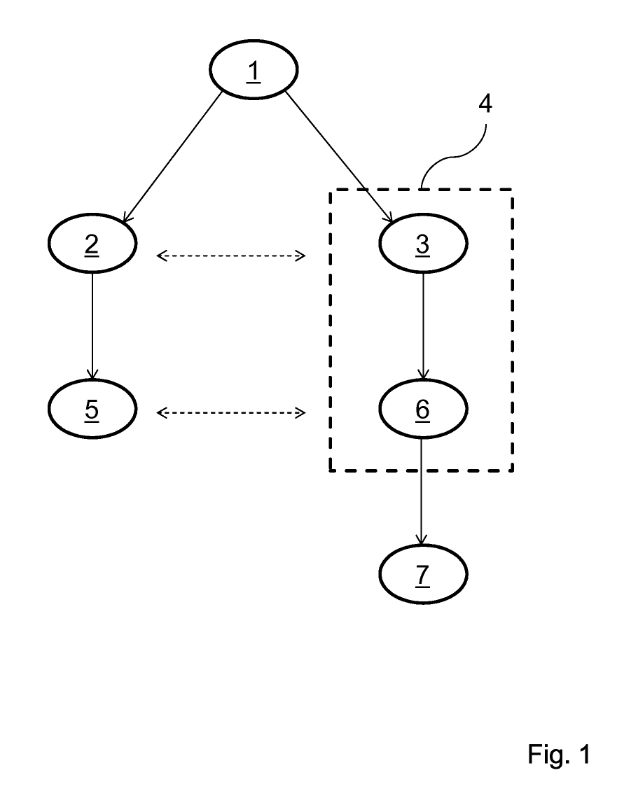

FIG. 1 shows, in a schematic view, a flow chart of an exemplary embodiment of a method according to the invention,

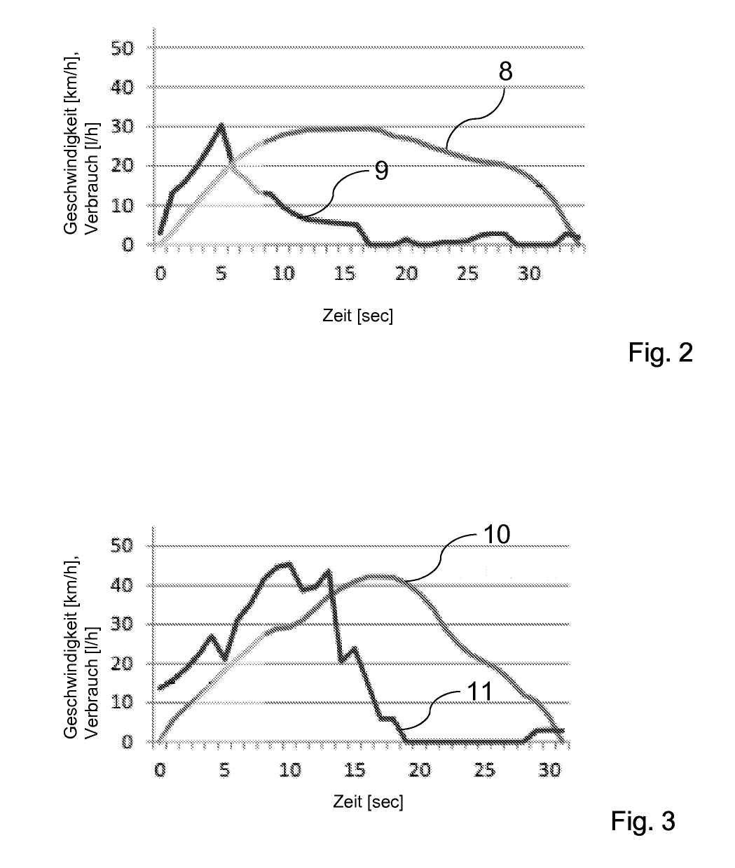

FIG. 2 shows the speed determined over the course of time and the fuel consumption determined over the course of time for a first vehicle operator,

FIG. 3 shows the speed determined over the course of time and the fuel consumption determined over the course of time for a second vehicle operator,

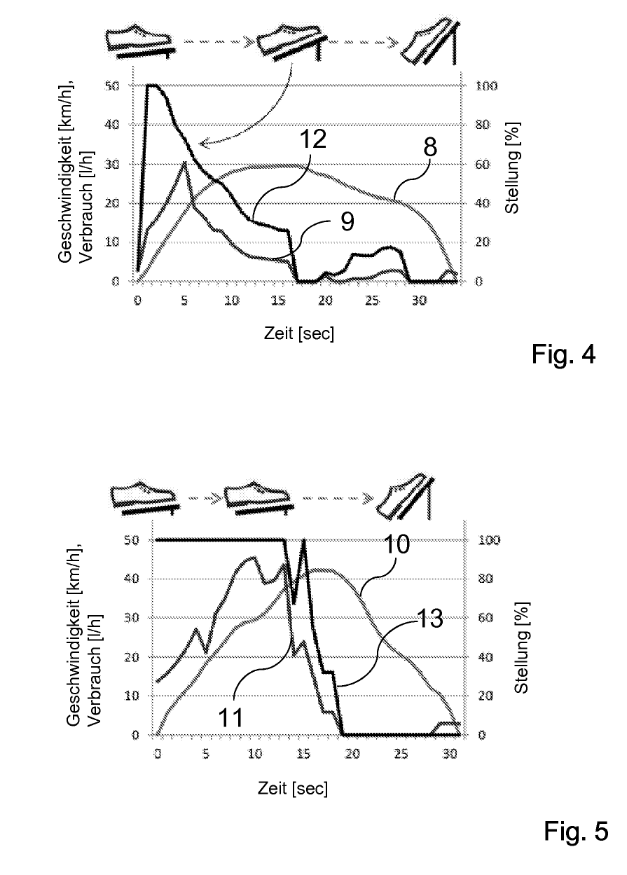

FIG. 4 shows the graph pursuant to FIG. 2, wherein the position of the gas pedal determined over the course of time is also indicated,

FIG. 5 shows the graph pursuant to FIG. 3, wherein the position of the gas pedal determined over the course of time is also indicated,

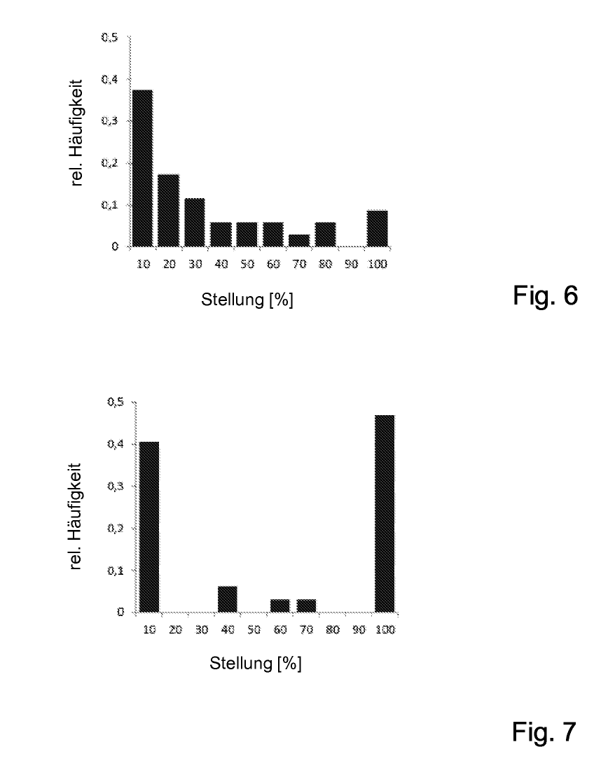

FIG. 6 shows the distribution of the relative frequencies of the different extents of actuations of the gas pedal for the curve depicted in FIG. 4,

FIG. 7 shows the distribution of the relative frequencies of the different extents of actuations of the gas pedal for the curve depicted in FIG. 5,

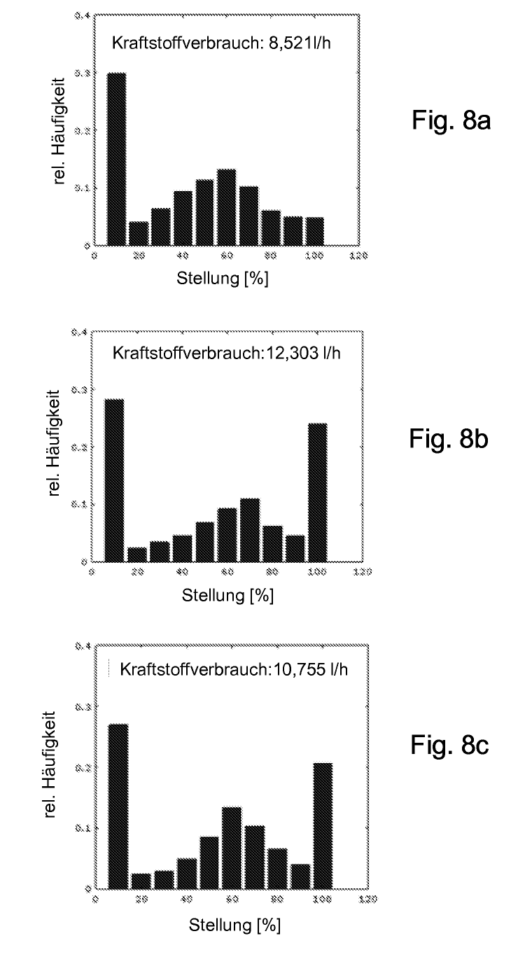

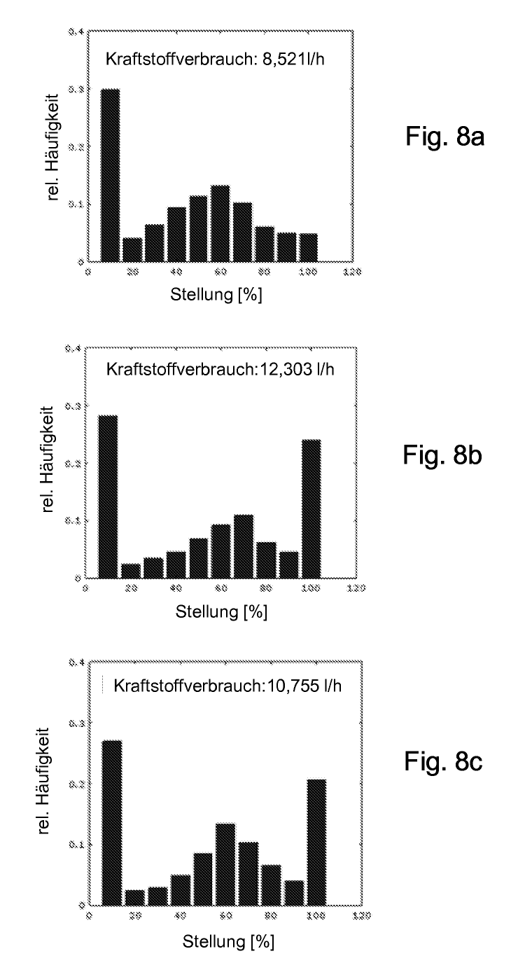

FIGS. 8a, 8b, 8c show exemplary distributions of the relative frequencies of different extents of actuations of the gas pedal during the driving of a route, or a work shift of a vehicle operator, and the associated fuel consumption values,

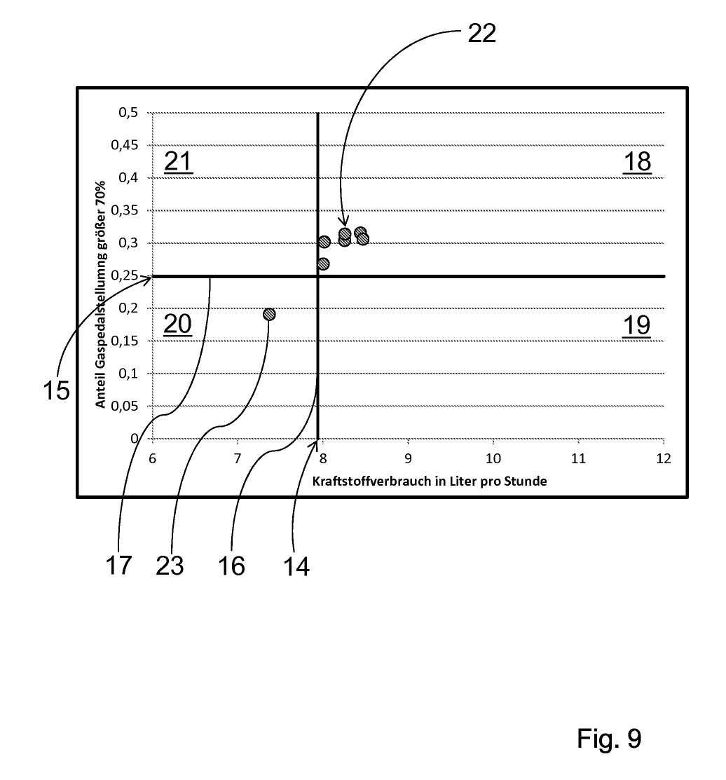

FIG. 9 shows a diagram for illustrating an implemented evaluation process according to one exemplary embodiment of the method according to the invention, or the system according to the invention, respectively, and

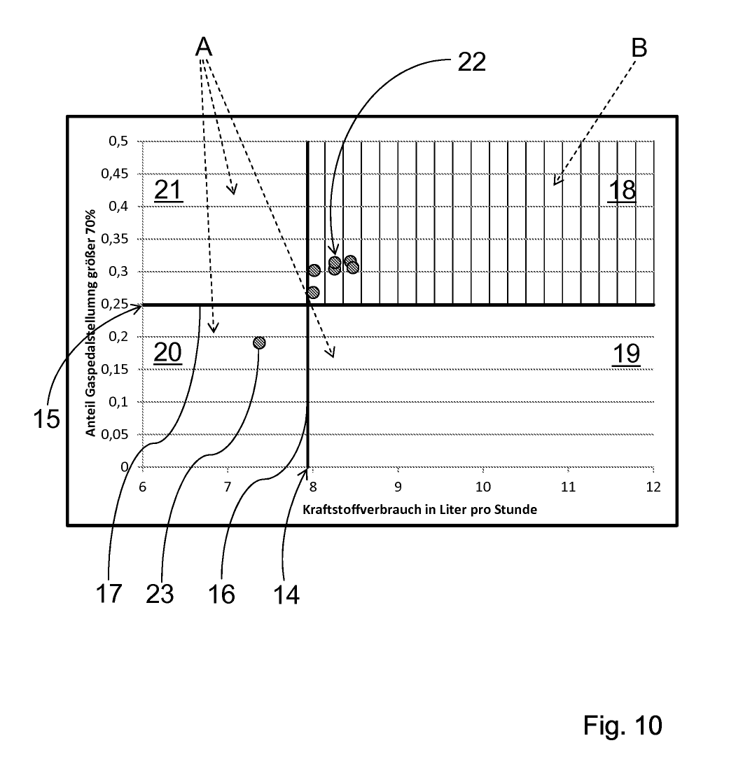

FIG. 10 shows the diagram pursuant to FIG. 9, wherein, according to one exemplary embodiment of the method according to the invention, or the system according to the invention, drives are classified with regard to being in need of improvement or not being in need of improvement.

FIG. 1 shows, in a schematic view, a flow chart of an exemplary embodiment of a method according to the invention. First, the position of the gas pedal over the course of time is detected by a detection device 1 via means for determining the gas pedal position, e.g. an inductive or capacitive movement and/or distance sensor. Moreover, the detection device 1 detects the fuel consumption over the course of time via corresponding further means, or sensors. Further parameters can also be detected by the detection device 1, if applicable, via corresponding means, based on which the driving behavior of the vehicle operator can be determined, if applicable. The data detected by the detection device 1 are stored in a memory unit 2 of the motor vehicle and/or transmitted to a memory unit 3 of a central—external—computer 4. The transmission can preferably be wireless—via a cellular network or via W-LAN—and optionally, in real time.

The data stored in the internal memory unit 2 can be further processed by a computer 5, disposed for example in the vehicle. In the same manner, the data stored in the memory unit 3 can be further processed by a computer unit 6 of the central computer 4. The further processing takes place thereby, such that the driving behavior of the vehicle operator, preferably after a route has been completed, or after a work shift, can be determined or evaluated from the data via an evaluation device.

The central computer 4, comprising the memory unit 3 and the computer unit 6, functions thereby as an evaluation device for evaluating the driving behavior of a vehicle operator. Alternatively or additionally, the memory unit 2 and the computing unit 5 can also function as an evaluation device disposed in the motor vehicle. The evaluation device can also be designed such that it is split up, such that the evaluation device is implemented on one hand by the central computer 4, and sub-functions of the evaluation device are disposed in the motor vehicle, or vice versa. If applicable, data communication can take place between the memory unit 2 or the computer unit 5, and the central computer 4, in particular in the framework of further processing the accumulated parameter data.

The evaluation device is configured and designed such that it calculates vehicle operator-specific characteristic values for a route driven by the vehicle operator. The vehicle operator-specific characteristic values are compared by the evaluation device with predefined threshold values, wherein the evaluation device draws conclusions from the comparison of the vehicle operator-specific characteristic values with the threshold values regarding the driving behavior of the vehicle operator for the route.

The further processed data, in particular the evaluation results for the driving behavior of the vehicle operator, can be displayed on a, preferably external, display 7 via the central computer.

The personal driving index for the vehicle operator can be displayed to the vehicle operator with the display 7, representing the development, e.g. an improvement or deterioration, of the driving behavior or manner of driving over numerous drives. An evaluation of a single driver of a vehicle fleet in a transport business can be displayed, based on the fuel efficiency of the driver resulting from his driving behavior. The evaluation can apply for a route driven, or a work shift, of the driver, such that the development of the driving behavior of a vehicle operator can be analyzed over the course of numerous work shifts.

The overall fuel efficiency in a vehicle fleet of a transport business or transit business can be improved in that the vehicle operators are given specific goals in order to motivate the vehicle operators to improve their evaluations. Moreover, daily, weekly or monthly reports or analyses regarding fuel efficiency of a vehicle operator are conceivable for a continuous and successful evaluation. Thus, both ecological aspects as well as significant savings in resources and costs can be achieved.

FIG. 2 shows the speed determined over the course of time, as well as the fuel consumption determined over the course of time, of a first vehicle operator. For this, the speed is plotted in km/h over time t in seconds in a first curve 8, and the fuel consumption is plotted in l/h over time t in seconds in a second curve 9.

It is clear from FIG. 2 that this is the typical course of an interval driving, such as occurring between stops on a bus route. This is characterized by a relatively short driving time of only ca. 35 seconds, in which the vehicle is first accelerated quickly to ca. 30 km/h, wherein this speed is maintained for only 8 seconds, after which the vehicle already slows down, in order to subsequently stop at the next bus stop. In the diagram shown in FIG. 2, the fuel consumption for this interval drive is ca. 0.064 liters.

FIG. 3 shows the speed determined over the course of time and the fuel consumption determined over the course of time for a second vehicle operator, wherein the driving route is identical to the driving route used as the basis for FIG. 2. For this, speed is plotted in km/h over time tin seconds in a third curve 10, and the fuel consumption is plotted in l/h over time tin seconds in a fourth curve 11.

The driving time required by the second vehicle operator is only negligibly shorter than the driving time depicted in FIG. 2, and takes specifically 32 seconds. It is substantial thereby that the first curve 8 and the third curve 10 deviate only slightly from one another, and in particular in the region between 0 seconds and 8 seconds, they correspond substantially to one another.

Nevertheless, the fuel consumption in FIG. 3 is ca. twice as high as in FIG. 2, at specifically 0.144 liters for this interval drive. It is clear from the comparison of FIGS. 2 and 3 that the speed determined over the course of time in interval driving is not suitable as a parameter for determining the driving behavior.

FIG. 4 shows the graph pursuant to FIG. 2, wherein the position of the gas pedal determined over the course of time is plotted as a fifth curve 12. The position of the gas pedal is given in percentages, wherein 100% corresponds to the position of a fully actuated gas pedal, and 0% corresponds to the position of a fully unactuated gas pedal.

FIG. 5 shows the graph pursuant to FIG. 3, wherein the position of the gas pedal determined over the course of time is also plotted herein as a sixth curve 13.

The comparison of the fifth curve 12 from FIG. 4 and the sixth curve 13 from FIG. 5 shows that these deviate significantly from one another over the entire course of time, and in particular in the region between 0 seconds and 8 seconds. As a result, it is clear that the position of the gas pedal over the course of time is ideally suited as a parameter for determining driving behavior.

FIG. 6 shows the distribution of the relative frequencies of the different extents of actuation of the gas pedal for the fifth curve 12 depicted in FIG. 4. FIG. 7 shows the distribution of the relative frequencies of the different extents of actuation of the gas pedal for the sixth curve 13 depicted in FIG. 5.

It is again clear from the comparison of FIGS. 6 and 7 that the first vehicle operator and the second vehicle operator actuate the gas pedal extremely differently, wherein specifically, the second vehicle operator, pursuant to FIG. 7, clearly more frequently fully actuates the gas pedal, i.e. “floors it.” Based on FIGS. 6 and 7, the different driving behaviors of the first vehicle operator and the second vehicle operator are very clearly visible. As a result, it is shown that the position of the gas pedal over the course of time is ideally suited as a parameter for determining driving behavior. Furthermore, the position of the gas pedal can be detected by an extremely simple sensor system.

FIGS. 8a, 8b, and 8c each show the distributions of the relative frequencies of different extents of actuation of the gas pedal while driving, or during a work shift of a vehicle operator, and the associated fuel consumption values. The horizontal axis describes the position of the gas pedal in percentages, and the relative frequencies of the respective gas pedal positions are given on the vertical axis. The average fuel consumption for the route pursuant to FIG. 8a is 8.521 l/h. The average fuel consumption for the route pursuant to FIG. 8b is 12.303 l/h. The average fuel consumption for the route pursuant to FIG. 8c is 10.755 l/h.

FIG. 9 shows a diagram illustrating the implemented evaluation process in accordance with one exemplary embodiment of the method according to the invention, or the system according to the invention. The vehicle operator is evaluated both in terms of his fuel consumption as well as in terms of his usage behavior with respect to the gas pedal. The portion of a gas pedal position higher than 70% of a vehicle operator is shown for a route driven in the diagram pursuant to FIG. 9 (vertical axis), i.e. the relative frequency of an at least 70% actuation of the gas pedal by a vehicle operator for a route driven, or a work shift, is plotted in relation to the average fuel consumption in liters per hour of the vehicle operator for the route driven/work shift (horizontal axis).

Moreover, predefined threshold values for classification in the framework of the comparison operation are shown in FIG. 9, specifically the threshold value 14, relating to fuel consumption, and the threshold value 15, relating to the gas pedal position. The threshold value 14 is illustrated by the threshold value line 16. The threshold value 15 is illustrated by the threshold value line 17. The average fuel consumption values from vehicle operators of a vehicle fleet for a route driven or for a work shift are taken into account for the threshold value 14 relating to fuel consumption, wherein here, concretely the mean of the average fuel consumption values of vehicle operators of the vehicle fleet lying within the 50^{th} percentile is determined as the threshold value 14. The average of the relevant frequencies of an at least 70% actuation of the gas pedal is determined as the threshold value 15 relating to the gas pedal position.

The threshold values 14 and 15 generated in advance are divided into four regions 18, 19, 20, and 21 over the corresponding threshold value lies 16 and 17 in the graph. Points to the left of the threshold value line 16 represent routes driven or work shifts of a vehicle operator with a sufficiently satisfactory fuel consumption characteristic value in comparison with the threshold value 14. Points to the right of the threshold value line 16 represent routes driven or work shifts of the vehicle operator having an excessive fuel consumption in comparison with the predefined threshold value 14. Points below the threshold value line 17 represent routes driven or work shifts of a vehicle operator having a sufficiently satisfactory gas pedal position value in comparison with the predefined threshold value 15. Points above the threshold value line 17 represent routes driven or work shifts of a vehicle operator having an excessively high gas pedal position value.

The point 22 and the point 23 represent numerous drives or work shifts of a vehicle operator corresponding to the derived and calculated characteristic values for the respective route. A total of seven drives of a vehicle operator are plotted in the diagram shown in FIG. 9. The two corresponding characteristic values for the drives represented by a point in FIG. 9 can be obtained from the distributions of the relative frequencies of different extents of actuation of the gas pedal during a route driven or during a work shift of a vehicle operator and the associated fuel consumption value, cf. e.g. FIGS. 6, 7, 8a, 8b, and 8c.

FIG. 10 shows the diagram pursuant to FIG. 9, wherein the regions 18, 19, 20, and 21 are divided up such that a “hit region” A and a “miss region” B are formed. A strike in the hit region A corresponds to a drive or work shift not in need of improvement, because a sufficiently satisfactory characteristic value for the fuel consumption or a sufficiently satisfactory characteristic value for the gas pedal position exists or has been determined for this route driven, taking into account the predefined threshold values relating to fuel consumption and gas pedal position. The hit region A thus comprises the regions 19, 20, and 21. The miss region comprises the region 18. A hit is represented in FIG. 10 by the point 21. The drives represented by the points 22 according to FIG. 19 are located in the miss region B, because they exhibit an excessively poor fuel consumption or an excessively poor fuel consumption characteristic value, and an excessively frequent high gas pedal position, i.e. excessively frequent strong gas pedal actuations, or an excessively high gas pedal position characteristic value, based on the predefined, or previously determined threshold values 14 and 15. Thus, the drives at points 22 are classified as being in need of improvement. The drive at point 23 is classified as not being in need of improvement.

Consequently, the hit region A represent routes driven by a vehicle operator having a sufficient fuel efficiency, wherein the driving behavior of the vehicle operator for such a route is distinguished by low fuel consumption and/or by mainly low gas pedal positions. The miss region B represents routes driven by a vehicle operator with insufficient fuel efficiency, wherein the driving behavior of the vehicle operator for such a route exhibits a high fuel consumption and a frequently high gas pedal position. Thus, it is possible for an acceptable drive, or a drive not in need of improvement, that the frequency of gas pedal positions may be higher than the corresponding threshold value 15, when the associated fuel consumption is lower than the corresponding threshold value 14. Moreover, the fuel consumption may be higher than the corresponding threshold value 14, when the relative frequency of the associated gas pedal positions is lower than the threshold value 15.

The classification of the seven drives of a vehicle operator pursuant to FIG. 9 is checked by means of a binomial test, in order to determine whether the vehicle operator—fundamentally over the course of numerous drives—has an acceptable, i.e. not in need of improvement, driving behavior, or whether the vehicle operator exhibits a poor driving behavior. For this, the following null hypothesis is implemented:
Null Hypothesis H₀:
For the probability p of a hit: p≥0.5

Thus, as an alternative hypothesis:
Alternative hypothesis H₁:
for the probability of a hit: p≥0.5

If the null hypothesis is rejected, it is thus plausible that the tested vehicle operator will drive during his work shift in a manner needing improvement with a probability of (1−p)>0.5 (thus greater than a random sampling). This means that if the null hypothesis is rejected, the driving behavior, or the manner of driving, of the vehicle operator is to be regarded as in need of improvement. If the null hypothesis is not rejected, the driving behavior, or manner of driving, of the vehicle operator is satisfactory, or not in need of improvement.

In the framework of the exemplary embodiment of a method according to the invention, illustrated in accordance with FIG. 9, a left-hand binomial test is implemented with the above hypotheses. The random variable X corresponds to the number of hits in the sample that is to be tested with a sample quantity n=7.

Under the null hypothesis: N₀:p≥0.5 (⇔p₀=0.5), the test statistic is distributed binomially, thus:

$$P ( X = k ) = B ( k \vert {p}_{0} , n ) = ( \begin{matrix}n \\ k\end{matrix} ) \cdot {{p}_{0 }^{k} ( 1 - {p}_{0} )}^{n - k}$$

Because the test statistic is distributed discretely, a given significance level α cannot be precisely maintained in general. For this reason, the discrete values should be selected such that \tilde{α} (exact significance level) is at a maximum under the auxiliary condition \tilde{α}≤α.

Thus:
Critical region: {0, . . . , c}
Wherein c is the greatest value for which the following applies:

$${\sum }_{k = 0}^{c} B ( k \vert {p}_{0} , n ) = {\sum }_{k = 0}^{c} ( \begin{matrix}n \\ k\end{matrix} ) \cdot {{p}_{0 }^{k} ( 1 - {p}_{0} )}^{n - k} = \tilde{α} \leq α$$

Discard the null hypothesis if X≤c.

The following values are thus obtained for the exemplary embodiment according to FIG. 10 for the probability distribution:

| Hits | Probability | Accumulated Probability |
|---|---|---|
| 0 | 0.0078125 | 0.0078125 |
| 1 | 0.0546875 | 0.0625 |
| 2 | 0.1640625 | 0.2265625 |
| 3 | 0.2734375 | 0.5 |
| 4 | 0.2734375 | 0.7734375 |
| 5 | 0.1640625 | 0.9375 |
| 6 | 0.0546875 | 0.9921875 |
| 7 | 0.0078125 | 1 |

Thus, the critical value c can be calculated with a significance level of α=0.1. This results in a critical range of c≤1.

Thus, finally: X=1≤1=c

Therefore, the null hypotheses for the samples plotted in FIG. 10 are rejected, conditional to the “just” one hit in the form of point 23. This results in the conclusion that the driving behavior of the vehicle operator, the seven drives of whom are illustrated in FIG. 10, qualifies on the whole as in need of improvement. If the null hypothesis were not rejected, then the vehicle operator, or his driving behavior, would be classified as not in need of improvement.

In order to create an automatic and computer implemented evaluation method in accordance with one exemplary embodiment of the invention, in particular in accordance with FIG. 10, the following steps may be implemented:
Determination and acquisition of parameter data with respect to the gas pedal position and fuel consumption of vehicle operators
Calculation and determination of threshold values
Classification of fuel consumption and the gas pedal position of the vehicle operator for each route driven/work shift as a function of the previously determined threshold values
Execution of a binomial test for each vehicle operator with respect to his classified routes driven/work shifts
Evaluation of the vehicle operator as in need of improvement or not in need of improvement, based on the results of the binomial test.

Regarding further advantageous designs of the method according to the invention and the system according to the invention, as well as the computer program according to the invention, reference is made to the general portion of the description and to the attached Claims, in order to avoid repetition.

Lastly, it is expressly noted that the exemplary embodiments of the invention described above serve only to explain the claimed teachings, which are not, however, limited to the exemplary embodiments.

### LIST OF REFERENCE SYMBOLS

1 detection device
2 memory unit (internal)
3 memory unit (external)
4 central computer
5 computer unit
6 computer unit (external)
7 display
8 first curve
9 second curve
10 third curve
11 fourth curve
12 fifth curve
13 sixth curve
14 threshold value (fuel consumption)
15 threshold value (gas pedal position)
16 threshold value line (fuel consumption)
17 threshold value line (gas pedal position)
18 region
19 region
20 region
21 region
22 point
23 point
A hit region
B miss region

1. A method for evaluating the driving behavior of a vehicle operator with a motor vehicle, wherein parameters describing the driving behavior are determined, wherein the fuel consumption over the course of time is determined as a parameter, wherein the position of the gas pedal over the course of time is determined as a further parameter, wherein vehicle operator-specific characteristic values for the route driven by the vehicle operator are derived or calculated from the determined parameters, wherein the vehicle operator-specific characteristic values are compared with predetermined threshold values, and wherein conclusions are drawn from the comparison of the vehicle operator-specific characteristic values with the threshold values regarding the driving behavior of the vehicle operator.

2. The method according to claim 1, wherein the determined fuel consumption and the determined position of the gas pedal, or the characteristic values derived therefrom, are placed in relation to one another.

3. The method according to claim 1, wherein only predefined driving sections of the route driven are taken into account for determining the parameters or for calculating the characteristic value from the determined parameters.

4. The method according to claim 3, wherein the predefined driving sections have a maximum driving section time of 15 minutes or no more than 5 minutes or no more than 2 minutes or no more than 1 minute.

5. The method according to claim 1, wherein the route driven has a driving time of at least 30 minutes or at least 1 hour.

6. The method according to claim 1, wherein the average fuel consumption of the vehicle operator is calculated for one, or the, route driven as the vehicle operator-specific characteristic value relating to fuel consumption.

7. The method according to claim 1, wherein the frequency or the relative frequency of a predefined actuation extent of the gas pedal or a minimum gas pedal actuation, is calculated as the vehicle operator-specific characteristic value relating to the gas pedal position.

8. The method according to claim 1, wherein the average of the mean fuel consumption values of a predefined number of vehicle operators is calculated or determined as the threshold value relating to fuel consumption.

9. The method according to claim 8, wherein the average of the frequencies of a predefined actuation extent of the gas pedal belonging to the average fuel consumption values of the predefined number of vehicle operators is calculated or determined as the threshold value relating to the gas pedal position.

10. The method according to claim 1, wherein the driving behavior for the route driven, or for a route driven, is classified as either being in need of improvement or not being in need of improvement, based on the comparison of the characteristic values with the corresponding threshold values.

11. The method according to claim 1 wherein the parameters for numerous drives of the vehicle operator are determined, wherein a vehicle operator-specific characteristic value relating to fuel consumption and a vehicle operator-specific characteristic value relating to the gas pedal position are derived or calculated for each drive.

12. The method according to claim 1, wherein a classification of numerous drives of the vehicle operator is checked by means of a hypothesis test or by means of a binomial test, wherein conclusions are drawn on the evaluation of the driving behavior of the vehicle operator from the check.

13. The method according to claim 12, wherein it is determined with the hypothesis test whether the vehicle operator drives a route with a driving behavior not in need of improvement with a probability of p≥0.5.

14. The method according to claim 13, wherein the threshold values are recalculated if the driving behavior of a predefined portion of the vehicle operators is evaluated as not being in need of improvement.

15. A system for evaluating the driving behavior of a vehicle operator with a motor vehicle, comprising a detection device disposed in the motor vehicle, for determining parameters describing the driving behavior, and comprising an evaluation device for evaluating the driving behavior of a vehicle operator, wherein the detection device includes means for determining the fuel consumption over the course of time, wherein the detection device includes further means for determining the position of the gas pedal over the course of time, and wherein the evaluation device is configured such that it calculates vehicle operator-specific characteristic values for a route driven by the vehicle operator from the determined parameters, compares the vehicle operator-specific characteristic values with predefined threshold values, and draws conclusions regarding the driving behavior of the vehicle operator from the comparison of the vehicle operator-specific characteristic values with the threshold values.

16. A computer program product, having computer program code for executing a method according to claim 1, wherein the computer program is executed in a computer.

17. The method according to claim 7, wherein the minimum actuation extent lies in a range of 50% to 100% actuation of the gas pedal or in a range of 50% to 75% actuation of the gas pedal or in a range of 50% to 60% actuation of the gas pedal.

18. The method according to claim 8, wherein the average of the fuel consumption values of the vehicle operators lying within the 70^{th} percentile is calculated or determined as the threshold relating to fuel consumption, or
wherein the average of the fuel consumption values of the vehicle operators lying within the 60^{th} percentile is calculated or determined as the threshold relating to fuel consumption, or wherein the average of the fuel consumption values of the vehicle operators lying within the 50^{th} percentile is calculated or determined as the threshold relating to fuel consumption.

19. The method according to claim 9, wherein the average of the relative frequencies of a predefined minimum actuation extent of the gas pedal is calculated or determined as the threshold value relating to the gas pedal position, wherein the minimum actuation extent lies in a range of 50% to 100% actuation of the gas pedal or in a range of 50% to 75% actuation of the gas pedal or in a range of 50% to 60% actuation of the gas pedal.

20. The method according to claim 1, wherein the method is for use with vehicle fleets in public mass transit or inner city traffic.
